(19) United States
(12) Patent Application Publication
(10) Pub. No.: US 2023/0080937 A1
(43) Pub. Date: Mar. 16, 2023

(54) SYSTEM FOR MONITORING CARGO WITHIN CONTAINERS DURING THEIR JOURNEY

(71) Applicant: TRACKIT GLOBAL LTD., Winchester, Hampshire (GB)

(72) Inventors: Avner Eliahu AZULAI, Tel Aviv (IL); Nadav ZIN, Tel Aviv (IL); Israel RADOMSKY, Herzliya (IL); Avinoam Shlomo LASRY, Beer-Sheva (IL)

(21) Appl. No.: 17/904,532

(22) PCT Filed: Feb. 18, 2021
(86) PCT No.: PCT/IL2021/050192

§ 371 Date: Aug. 18, 2022

Related U.S. Application Data
(60) Provisional application No. 62/978,340, filed on Feb. 19, 2020.

(51) Int. Cl. G08B 21/18

(52) U.S. Cl. CPC G08B 21/182

(57) ABSTRACT

The invention also relates to a device for monitoring a container according to claim 22, comprising: (A) a plurality of sensors divided into a first group of sensors and a second group of sensors; and (B) an autonomous sampling- rate manager which is configured to: (a) based on one or more excess of bound interrupts from said first group of sensors and a first group threshold, determine whether to wake up the device to sample and store within a memory storage a sample-record reflecting data measured by both said first and second groups of sensors; and (b) based on measurements from said second group of sensors and a second- group threshold, determine whether to increase or decrease a period until a next sampling of the sensors.

### FIELD OF THE INVENTION

The invention relates in general to the transport of cargo within containers. More specifically, the invention relates to a system for monitoring the cargo’s integrity and condition during the journey, determining events of possible damage, recording the events, and reporting to a central monitoring location in near real-time.

### BACKGROUND OF THE INVENTION

Freight containers are reusable transport and storage units for moving products between locations or countries. While standard containers generally provide a protected space for transportation, there are still many cases where the cargoes arrive damaged at the destination due to one or more of the following reasons:
a. The cargo was not organized well within the container;
b. The sealing of the container was damaged;
c. The container suffered excessive vibrations or impacts during the loading, unloading, or transportation;
d. The container was opened on the way with no authorization from the cargo’s owner;
e. Rough weather conditions;
f. The entry of saltwater during sea transportation;
g. Fire;
h. Etc.

In cases where the cargoes are insured, an insurance claim is typically filed upon discovery of damage. In many cases, the insurer cannot determine the real cause for the damage or the party responsible for the negligence or wrongdoing out of the various transport operators involved or by others on the long way from the source to destination. The insurer also cannot determine whether the damage was caused by weather or another environmental cause.

There are many cases where the transported cargo exhibits no visible signs of damage upon arrival. Later on, however, at the time when the damage is discovered, the period for claiming damages due to negligence or wrongdoing by any party on the way has passed, leaving the consumer uncompensated.

The standard container is a sealed box whose external walls are made of steel or another metal with additional isolation material. This sealed container’s structure eliminates the possibility of wireless transmission from within the container to the external world. Only refrigeration containers are provided as a standard with suitable connectors that allow wired transmission from the internal to the container’s external surface. However, these refrigeration containers occupy only a very small portion of the total number of currently used containers.

The art has provided various monitoring systems (including sensors and recorders) within containers to determine abnormal conditions and events. Those isolated data collection devices can be examined when the cargo is offloaded at the end of the journey. However, none of the prior art systems provides a low power consumption, near real-time (when network is available), objective and secure data reports relating to conditions and events inside the container during transport.

The typical standard container substantially forms a Faraday cage that eliminates wireless communication from within the container to the outside world. Therefore, prior art systems attempting to connect between an internal events recorder and a repository center via the GSM network (or another) have failed.

Another prior art approach has provided a pair of internal and external communications devices. The internal device (recorder) includes or communicates with various sensors within the container, and it collects and records data. The external device attached to the external door’s facet is connected to the internal recorder by a wired connection maneuvered via the door sealing. However, this wired approach bends and damages the container’s sealing, resulting in damages to the transported goods. This approach is objected to by insurance companies for not meeting the sealing ISO 6346 (Shipping Container Standard). Another solution for transmission between the internal recorder and the external device is therefore desired.

In any case, no matter which (wired or wireless) approach is selected, both the internal device (recorder) and the external device are battery-operated, and the consumption of energy by the devices is critical. However, a reliable recording of data requires a high rate of sensor-sampling (by the internal device), resulting in very high battery energy consumption. A lower rate of sensor-sampling results in the potential of losing essential data and events. A solution to this problem is therefore desired.

It is an object of the invention to provide a container’s near real-time monitoring system that overcomes prior art systems’ drawbacks. By “near real-time,” it is meant that reports are transmitted as close to the sensors’ measurements occurrence, at least when a network connection is available.

Another object of the invention is to provide a container near real-time monitoring system, in which the prior art’s necessity to maneuver a wire through the container’s door-sealing to enable communication is eliminated.

It is still another object of the invention to provide a container near real-time monitoring system that includes a smart sampling-rate management that reduces energy consumption from batteries.

Other objects and advantages of the invention will become apparent as the description proceeds.

### SUMMARY OF THE INVENTION

The incention relates to a system for monitoring a container’s cargo during its journey, comprising: (A) a repository center; (B) an internal device which is positioned within the container and is configured to communicate with an external device; and (C) said external device attached to an external surface of the container, the external device is configured to communicate with said internal device and with the repository center; wherein (D) each of said internal and external devices comprising: (i) a plurality of sensors, each sensor being configured to sense a status of the container; and (ii) an autonomous sampling-rate manager configured to dynamically alter a sampling-rate of the sensors based on sensing measurements made by said sensors.

The incention also relates to a system for monitoring a container’s cargo during its journey, comprising: (A) a repository center; (B) an internal device which is positioned within the container and is configured to communicate with an external device; and (C) said external device attached to an external surface of the container, the external device is configured to communicate with said internal device and with the repository center; wherein (D) each of said internal and external devices comprising: (i) a plurality of sensors, each sensor being configured to sense a status of the container, said plurality of sensors being divided into a first group of sensors and a second group of sensors; and (ii) an autonomous sampling-rate manager configured to alter a sampling-rate of the sensors by: (a) receive from one or more of said first group’s sensors an interrupt indicating an excess of bound, as defined for each of said sensors, respectively; (b) following an interrupt, calculate a weighted score for said first group of sensors, and only if said evaluation results in a value above a first-group threshold: (b.1.) wake-up the device from a sleeping mode, sample both said first and second groups of sensors, and store within a memory storage a sample-record reflecting measurements from both the first group of sensors and from the second group of sensors; and (b.2.) calculate a weighted score for said second group of sensors, and if the evaluation results in a score above a second-group threshold, increase the sampling-rate of the device; (c) otherwise, either reduce or leave said sampling-rate unchanged, and return the device into a sleeping mode, waiting for a next interrupt.

The invention also relates to a device for monitoring a container, comprising sensors and a sampling-rate manager, whrein the sampling rate of the sensors is dynamically altered by said sampling-rate manager based on sensing measurements made by said sensors.

The invention also relates to a device for monitoring a container according to claim 22, comprising: (A) a plurality of sensors divided into a first group of sensors and a second group of sensors; and (B) an autonomous sampling-rate manager which is configured to: (a) based on one or more excess of bound interrupts from said first group of sensors and a first group threshold, determine whether to wake up the device to sample and store within a memory storage a sample-record reflecting data measured by both said first and second groups of sensors; and (b) based on measurements from said second group of sensors and a second-group threshold, determine whether to increase or decrease a period until a next sampling of the sensors.

### BRIEF DESCRIPTION OF THE DRAWINGS

FIG. 1 illustrates in a block diagram form a container monitoring system, according to an embodiment of the invention;

FIG. 2 illustrates a possible positioning on a container of the internal and the external devices;

FIG. 3 illustrates the structure of the internal device in a block diagram form, according to an embodiment of the invention;

FIG. 4 illustrates the structure of the external device in a block diagram form, according to an embodiment of the invention; and

FIG. 5 illustrates in a block diagram form a procedure for sampling, storing, and defining (adjusting) the sampling-rate in a device, according to an embodiment of the invention.

### DETAILED DESCRIPTION OF PREFERRED EMBODIMENTS

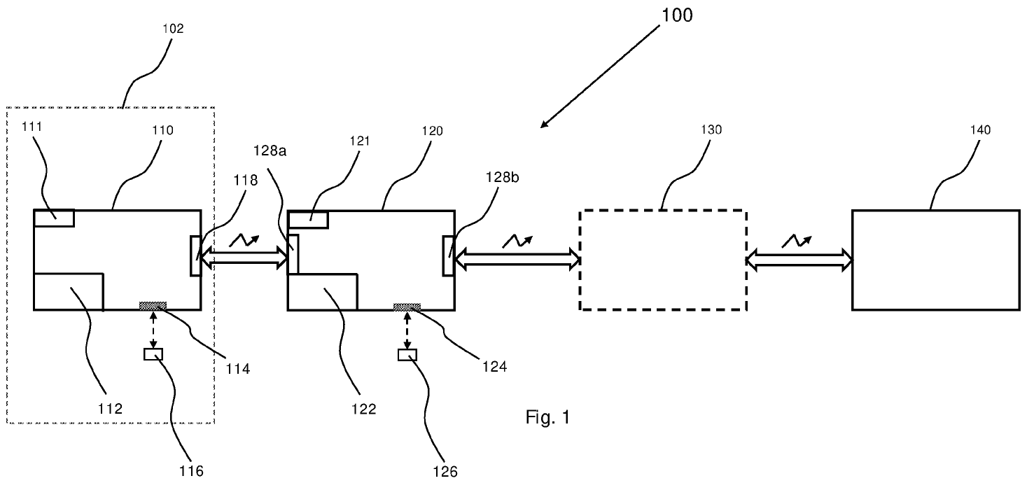

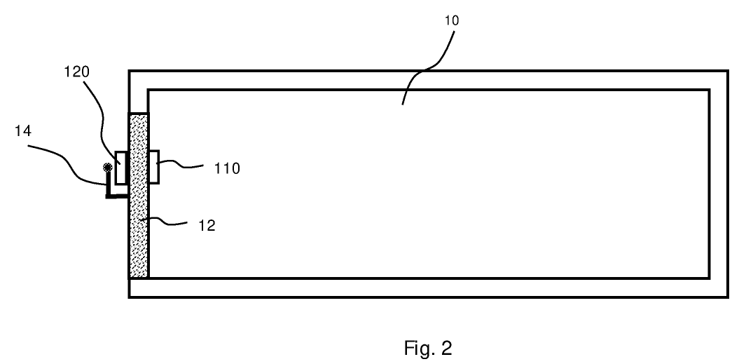

FIG. 1 illustrates in a block diagram form a container monitoring system, according to an embodiment of the invention. An internal device 110 is positioned within container 102. Internal device 110 includes within its casing several (in some cases more than twenty) internal sensors 112, and a port 114 for optional connection to one or more external sensors 116. The internal device also includes an autonomous sampling-rate manager 111. Sampling-rate manager 111 applies a unique and autonomous sampling-rate regime to activate and sense the specific measurements of sensors 112 and optional sensors 116. Applying a dynamic sampling-rate regime reduces energy consumption, as each sampling session creates a “sample-record” that has to be first stored and then transmitted to the repository center 140 (via external device 120). The transmission of sample records accumulated within the internal and external devices, 110 and 120, respectively, to the repository center 140 is the highest consumer of energy in both the internal and the external devices. This energy consumption proportionally depends on the transmission rate (namely, periods between transmissions) and the number of sample-records transmitted. Therefore, the sampling-rate manager 111 optimizes the number of reading sessions and the number of stored sample-records that are eventually transmitted to the repository center. Therefore, the sampling-rate affects the number of stored sensors-reading sample-records, the number of transmissions to the repository center (in general), and the transmission durations. The sensed sample-records are temporarily stored within the internal device 110, and periodically or upon events transmitted to the external device 120 via transceiver 118. As shown in FIG. 2, the internal device 110 is positioned within container 10, preferably attached (for example, by magnets) to a wall of the container, most preferably to the internal surface of the container’s door 12. External device 120 is similarly attached to an external wall of the container. Using an ISM band, a reliable and efficient transmission (in terms of power consumption) can still be established between the two devices, 110 and 120.

Back to FIG. 1, the structure of external device 120 is somewhat similar to the structure of internal device 110 (similar references indicate similar functionalities - the differences will be discussed in more detail hereinafter). In some similarity to the internal device 110, external device 120 includes a first transceiver 128a (to communicate with the internal device in an ISM band), an additional second transceiver 128b (for communicating with the repository center via a GSM/LORA or WAN, when available), internal sensors 122, and port 124 for optional connection to external (one or more) sensors 126. The communication between external device 120 and internal device 110 is bidirectional. In an embodiment of the invention, the internal and external devices synchronize their sample-records. Following the synchronization, each of the two devices stores the entire accumulated data of both (i.e., each device forms a backup of the other). Other data exchange between the two devices may include updates issued either within the external device or received at the external device from another source. For example, the additional data may include clock synchronization (at least in the initialization stage), handshaking information, updates to the firmware and in some cases, commands received from the repository center 140. The external device 120 periodically (or otherwise, if a connection cannot be established) transmits via the second transceiver 128b (preferably GSM, when available, or low power wide area network 130, when available) the accumulated sample-records that it receives from the internal device 110, and possibly sample records that it accumulates on its own, to the repository center 140. External device 120 is externally attached to a container’s wall, preferably as close as possible to the internal device 110 (attached internally to the same wall - see FIG. 2). In one embodiment of the invention, the internal device 110 is attached (for example, by magnets) to the internal surface of the door, and the external device is secured to the door’s handle and/or the external surface of the door, most preferably to the container’s door. In some embodiments, and for better security, the external device may include an e-seal, attaching the device to the container’s handle 14. The communications between the internal device and the external device, and the communication to the repository center 140, are preferably encrypted.

Each of the internal and external devices (110 and 120, respectively) has its unique ID to eliminate interception with other similar devices in the container’s vicinity. Hundreds, even thousands of internal-external pairs of devices may exist on separate containers within a radius of several hundreds of meters, for example, during sea shipment or containers’ storage in a port, before or after shipment. A pairing procedure is also performed between the internal and the external devices to eliminate interceptions. Once the two devices are paired, they communicate with each other and with the central repository in a secure encrypted format.

Repository center 140 receives periodic reports from many (for example, tens of thousands or more) external devices of containers located throughout the globe. Each of the reports includes at least (a) the identifications of at least the sending external device (or preferably of both the internal and the external devices); (b) timestamp of the report and each specific sample-record; (c) the specific measurement that was measured by each sensor (within the sample-record); (d) optionally the container’s global location (if a GPS reading was available at the session’s time); etc. The sensors’ measurements and the reports form a raw basis for the repository center to determine a variety of damaging events or irregularities as close as possible to their time of occurrence or after each container arrived at its destination.

The repository center’s 140 analysis may conclude that damage or an unexpected event occurred to the cargo even when the container is still on its way (without waiting to the end of the journey), enabling the sender to take action even before arriving at the destination. The analysis may determine extreme conditions or events and may alert even in cases of non-visible damages, and these determinations may form a basis to resolve disputes.

The saving of energy has the utmost importance in portable internal and external devices 110 and 120. Each container’s journey may last several weeks, and in some cases, their storage in ports may span several additional weeks. The transmissions during the journey consume a significant amount of energy. Therefore, it is critical to optimize sample-rates and communication rates within and between journeys. In one embodiment, a rechargeable battery may be included within the two devices. In another embodiment, a disposable (one-time) battery may be used. In both cases: (a) the two devices are continuously at sleeping modes -they wake up for only specific short-duration activities, such as sensor readings, synchronization between devices, transfer of sample-records, possibly receiving data or commands from the repository center 140, etc.; (b) an autonomous mechanism is used within each device to set up a dynamic sampling-rate depending on the actual sensors’ readings.

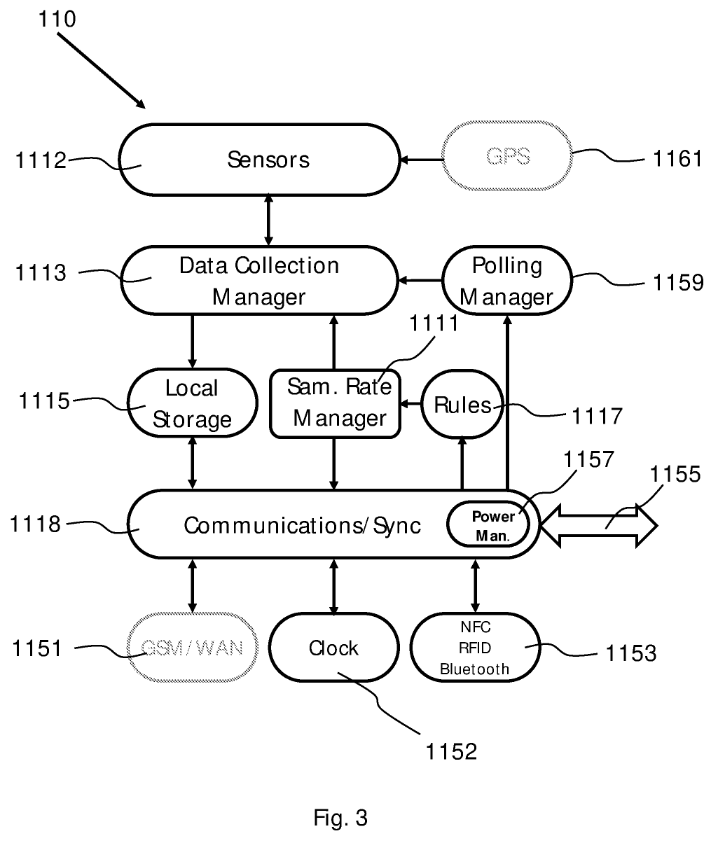

FIG. 3 illustrates the structure of the internal device 110 in a block diagram form. The transceiver 1118 communicates with the transceiver of the external device 120 via an ISM communication band 1155. Transceiver 1118 typically conveys sample-records of sensor readings to the external device 120. Preferably, the two devices 110 and 120 synchronize their respective sample-records such that each can serve as a backup of the other. At least one time, they also synchronize their respective clock 1152. The devices 110 and 120 are typically in a sleep mode most of the time (to save energy). Devices 110 and 120 wake-up from time to time by the power manager 1157 (1257 in the external device) to perform their tasks (such as synchronization with the between devices, reading of sensors, etc.). Data collection manager 1113 reads from the various sensors 1112, and stores the measurements as sample-records within the local storage 1115. Sampling-rate manager 1111 dynamically defines the sampling-rate from the sensors based on a set of rules 1117 and actual reading values from at least a portion of the sensors’ set. More specifically, and to reduce the number of sample-records, the sampling-rate manager 1111 governs the sampling-rate and, in-fact, defines (based on actual sensing) when sensor readings will be stored within storage 1115. Optional polling manager 1159 may instruct the data collection manager 1113 in some relatively rare cases to perform unscheduled sensor readings where a respective command is received from the repository center (via the external device), i.e., by bypassing the sampling rate manager 1111. The GPS unit 1161 is inactive within the internal device. Similarly, the NFC, RFID, and Bluetooth units are generally inactive within device 110 - they may be used during initialization, pairing with the external device, or offline maintenance.

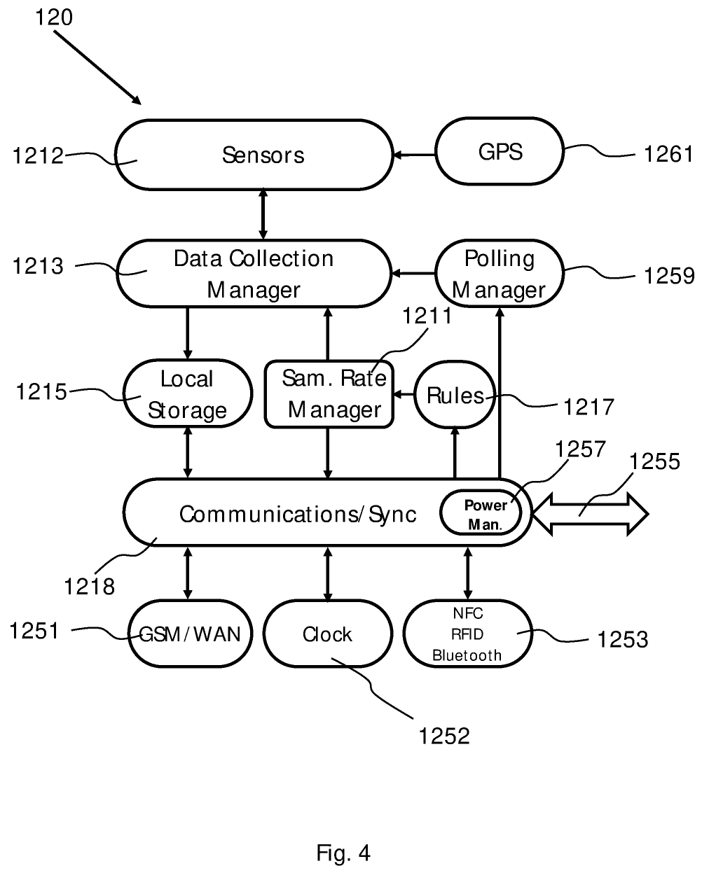

FIG. 4 illustrates the structure of the external device 120 in a block diagram form, according to one embodiment. The structure of device 120 is similar to the internal device’s structure, and each similar numeral reference to an element in FIG. 3 refers to a similar functionality mutatis mutandis. The transceiver 1218 communicates with the transceiver of the internal device 110 via an ISM communication band 1255. Transceiver 1218 typically conveys sample-records of sensor readings to the internal device 110. Preferably, the two devices, 110 and 120, synchronize their respective sample records such that each device can serve as a backup of the other. At least once, the two devices also synchronize their respective clock 1252. The devices 110 and 120 are typically in a sleep mode most of the time, and each of them wakes-up from time to time by the power manager 1257 (1157 in the internal device) to perform its tasks (such as synchronization with the internal device, reading of sensors 1212, transmission to the repository center, etc.). Data collection manager 1213 reads measurements from the various sensors and stores them as sample-records within the local storage 1215. Sampling rate manager 1211 dynamically defines the sampling rate based on rules 1217 and actual reading values from at least a portion of the sensors’ set. More specifically, and to reduce the number of sample-records, the sampling rate manager 1211 governs the rate of sensor readings and defines when readings will be stored within storage 1215 (or otherwise ignored). Optional polling manager 1259 may instruct the data collection manager 1213 in some rare cases to perform unscheduled sensor readings where a respective command is received from the repository center, i.e., bypassing the sampling rate manager 1211. Device 120 periodically (or when a network connection becomes available) establishes a networking connection with a GSM or WAN network 1251 to convey the accumulated sample-records (i.e., those not yet transmitted) to the repository center 140. The GPS unit (sensor) 1261 is active within the external device 120, and it periodically acquires a location for association with respective sample-records. The NFC, RFID, and Bluetooth units may be used during initialization, pairing with the external device, uploads, or offline maintenance purposes.

It should be noted that rules 1117 and 1217 may, at least partially depend on the specific container, the specific cargo, or the specific journey.

As said, an important feature of the invention is the management of the sensor’s readings. Each stored sample record must be first synchronized (between the internal and external units 110 and 120) and then transmitted to the repository center 140. The synchronizations and transmissions to the repository center are the highest energy consumers of the system. Moreover, the energy consumption is proportional to the number of sample-records and sample-record size. Therefore, each of the internal and external units applies a unique energy-saving regime that involves two sequential decisions: (a) based on partial sensors reading, decide whether to store the respective complete read sample-record; and, (b) following each storage sample-record, decide whether to modify the sampling rate (for example, switch to a higher or lower sampling-rate from within several predefined rates).

In an embodiment of the invention, the technique involves: (a) a set of interrupt sensors s₁-s_{g}, whose power consumption is negligible, and b) a set of non-interrupt sensors, s_{g+1}-sₙ, whose measurements involve current consumption and are only activated when an interrupt is issued by one or more of said first group’s sensors. Also, a number of sampling-rates (i.e., periods) is defined, for example: 10 minutes, 30 minutes, 60 minutes, and 120 minutes. In a normal condition of the container, the lowest sampling rate (e.g., 120 min. period) is used as a default, and a sampling record is acquired and stored every 120 minutes. The sampling rate increases upon divergence from the normal conditions and may gradually return to the default sampling rate upon expiring of the abnormal condition.

In the first stage, only sensors from the first group operate, consuming very little or no energy. When one or more of the first-group sensors are triggered (i.e., exceeds its defined limits), an aggregated score is calculated for the first group based on it’s respective sensor weights and compared with the predefined first group threshold. If the first group’s weighted score exceeds the first group’s threshold or the current period (implied by the currently used sampling rate) has expired, then the rest of the sensors (namely, those of the second group) are measured, and the entire set of measurements (of both groups) is stored as a sample-record and a new period is set for the next scheduled sample. Moreover, if the weighted score of the second group’s measurement exceeds the second-group threshold a pre-defined number of times in a row (weighted by recency) then the sampling rate is increased to a higher rate; otherwise, the sampling-rate remains unchanged. Conversely, if the weighted score remains under the threshold a pre-defined number of times in a row (weighted by recency) then the sampling rate is decreased to a lower rate. In this manner, the sampling-rate becomes higher when an abnormality is determined or becomes lower during expected and normal conditions.

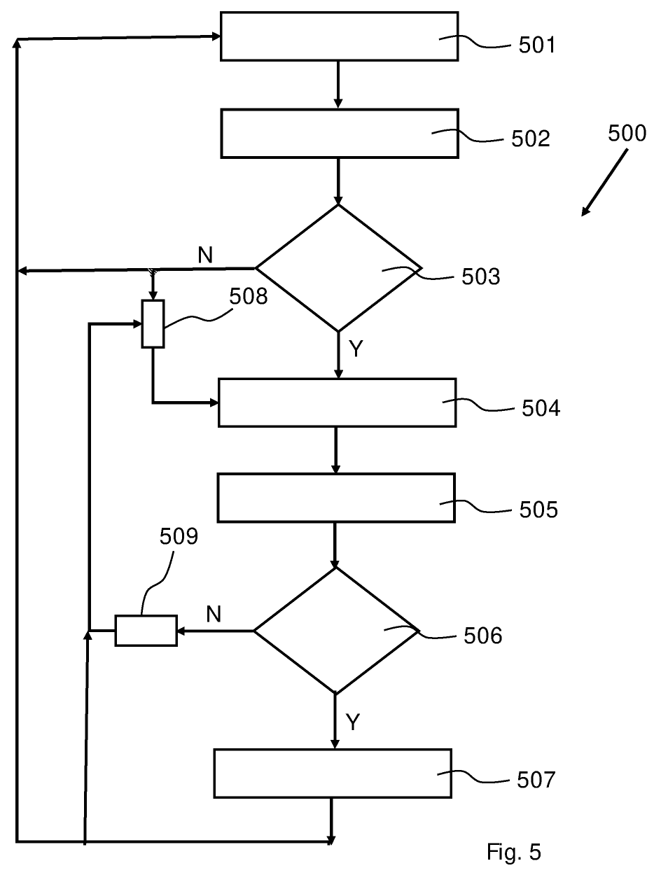

FIG. 5 illustrates in a block diagram form a procedure 500 for sampling, storing, and defining the sampling-rate in a device (110 or 120), according to an embodiment of the invention. In step 501, only the first group’s sensors operate while consuming very little or no current. Preferably, each sensor in the first group receives a specific weight relative to its importance in detecting irregularities (the total weight of all the first group sensors is 100%). Each sensor from the first group is configured to issue an interrupt upon exceeding its predefined limit. In step 502, and upon an interrupt from one or more of the first group sensors exceeding their predefined limit, those specific sensors are weighted to obtain a weighted first group calculated value. In step 503, the weighted first group value is compared with a first group predefined threshold. If in step 503, the weighted first group calculated value does not exceed the first group predefined threshold, the first group’s measurements are ignored, and the device returns to its sleeping mode. The device either again waits in step 501 for possible interrupts from the first groups’ sensors, or after the currently used delay period 508 (defined by the current sampling rate), the procedure issues an interrupt to wake up the device and continues to step 504.

If, however, in step 503, the first group weighted value exceeds the first group predefined threshold or alternatively an interrupt comes from step 508 (whichever comes first), in step 504 the measurements of both the first group sensors and the second group sensors are all stored as a sample-record. In step 505, the actual measurements of the second group of sensors (or optionally of only those that exceed their respective predefined range defining normal container conditions) are weighted to obtain a weighted second group calculated value. In step 506, the weighted second group calculated value is compared with a second group predefined threshold. If in step 506 the weighted second group calculated value does not exceed the second group predefined threshold, step 509 does not modify the sampling-rate - period 508 until the next sampling. Step 509 increases period 508 (i.e., reduces the sampling-rate) if the non-exceeding of the threshold of step 506 is repeated several times, for example, 3 times. Then the procedure returns simultaneously to steps 501 and 508 for subsequent processing, as described before. If, however, in step 506, the second group weighted value exceeds the second group’s predefined threshold, step 507 reduces the period 508 until the next sampling session (or step 507 leaves period 508 as is if it is already the minimal period -namely highest sampling-rate). Then, after the respective delay period 508, the procedure returns to steps 501 and 508 each of which may issue an interrupt, as described before. As shown, the procedure applies an autonomous mechanism for (a) first deciding whether it is necessary to store a sample-record of entire sensor measurements (based on the first group’s sensor measurements); and (b) deciding whether to modify the sampling-rate based on a second group’s sensor measurements. In any case, the mechanism of the invention, as described, stores a sampling record either based on the current sampling rate or based on interrupts from the first group’s sensors.

### EXAMPLE

Table 1 provides an example of sensors and definitions that may be used within the monitoring devices of the present invention.

Table 1

| Group | Sensor# | Functionality | Sensor Range | Weight | Threshold Rate |
|---|---|---|---|---|---|
| 1 | 1 | Tilt | S1, R₁ max | 25% | 50% |
| | 2 | Shock | S2, R₂ max | 35% | |
| | 3 | Noise | S3, R₃ max | 15% | |
| | 4 | Pir (Human Detection) | S4, R₄ max | 25% | |
| 2 | 5 | Humidity | S5, R₅, ₁₋R₅,₂ | 15% | 40% |
| | 6 | Salinity | S6, R₆, ₁-R₆, 2 | 25% | |
| | 7 | IR flame | S7, R₇, ₁ -R₇, ₂ | 20% | |
| | 8 | Luminosity | S8, R_{8,}₁-R₈, 2 | 10% | |
| | 9 | Temperature | S9, R₉, ₁-Rg, 2 | 20% | |
| | 10 | Acceleration | S10, R_{10,1}- R_{10,}₂ | 10% | |

Group 1 includes four interrupt sensors: Tilt, Shock, Noise, and PIR (human-detection) . Each of the first group’s sensors can be aligned to a predefined maximal level (trigger) R_{x max}, respectively, and it can provide normal or excess of limit indications without consuming significant current. An excess of limit indication is used as an interrupt to wake-up the device. Moreover, each sensor in the first group posseses a respective percentage impotance value (weight). The weights of all the first group’s sensors accumulate to 100%. A threshold value is also defined for group 1 (in this case, 50%) . When one or more of the sensors exceeds their predefined limit, a weighted score for group 1 is calculated. If that score exceeds the first group threshold then the device is woken, all sensors are measured, and a sample-record is created and stored. Otherwise, if the weighted score of the first group’s sensors does not exceed the first group threshold, the device returns to its sleep mode.

The second group of this example includes six additional sensors. Each of the second group’s sensors provides a respective sensor measurement, which can be compared to a respective predefined range R_{x,1}-R_{x,2} for that sensor which signifies normal level. Furthermore, and in similarity to the first group’s sensors, each of the second group’s sensor has its own predefined weight, and the entire second group has its own predefined group threshold. Upon measurement of all the second group’s sensors, each sensor’s measurement is compared with its respective range to identify all out-of-bound measurements, that are in turn weighted to form the group’s score. If that score exceeds the second group’s threshold, it is concluded that a container and the cargo are in an abnormal state. Following such determination, the sampling rate is increased in order monitor the situation more frequntly. However, if during several second-group samplings (weighted by recency) it is found that the accumulated weights measurements no longer exceed the second group’s threshold, the sampling rate is reduced back to to its previous rate.

Based on the sample-records received, the repository center can determine the container’s condition throughout the journey. The repository center may augment incoming data with similar containers and cargoes to support machine learning models for pattern discovery.. Depending on the consumers’ requirements, analysis and reports may be provided either during or after the journey.

In some embodiments, the external device may use satellite communication rather than GSM communication. In another aspect, the data may be compressed before transmitting it to the repository center 140.

While some embodiments of the invention have been described by way of illustration, it will be apparent that the invention can be carried into practice with many modifications, variations, and adaptations, and with the use of numerous equivalent or alternative solutions that are within the scope of persons skilled in the art, without departing from the spirit of the invention or exceeding the scope of the claims.

1. A system for monitoring a container’s cargo during its journey, comprising:
a repository center;
an internal device which is positioned within the container and is configured to communicate with an external device; and
said external device attached to an external surface of the container, the external device is configured to communicate with said internal device and with the repository center; wherein
- each of said internal and external devices comprising:
a plurality of sensors, each sensor being configured to sense a status of the container; and
an autonomous sampling-rate manager configured to dynamically alter a sampling-rate of the sensors and storage of sample records based on sensing measurements made by said sensors.

2. The system of claim 1,
wherein the autonomous sampling-rate manager is configured to alter the sampling-rate of the sensors by:
(a) receive from one or more of said first group’s sensors an interrupt indicating an excess of bound, as defined for each of said sensors, respectively;
(b) following an interrupt, calculate a weighted score for said first group of sensors, and only if said evaluation results in a value above a first-group threshold: (b. 1.) wake-up the device from a sleeping mode, sample both said first and second groups of sensors, and store within a memory storage a sample-record reflecting measurements from both the first group of sensors and from the second group of sensors; and (b.2.) calculate a weighted score for said second group of sensors, and if the evaluation results in a score above a second-group threshold, increase the sampling-rate of the device;
(c) otherwise, either reduce or leave said sampling-rate unchanged, and return the device into a sleeping mode, waiting for a next interrupt.

3. The system of claim 2, wherein said next interrupt is issued either by the sampling rate manager due to expiry of the period resulting from the current sampling rate, or by one or more of said first group’s sensors.

4. The system of claim 2, wherein said reduction of said previously used sampling-rate occurs after several times of non-exceeding the first-group’s threshold or the second-group’s threshold.

5. The system of claim 2, wherein said first group’s sensors consume a negligible current compared to the current consumed by said second group of sensors.

6. The system of claim 2, wherein said calculation of the weighted score for said first group of sensors and said calculation of the weighted score for the second group of sensors are based on a predefined weight which is given to each sensor.

7-11. (canceled)

12. The system of claim 2, wherein said internal and external devices are configured to synchronize between them respective sample-records, thereby to form a backup of accumulated data in both of said devices.

13. (canceled)

14. The system of claim 2, wherein said external device further comprising a GPS sensor to acquire location, and said acquired location is further associated with at least several of said sample-records, respectively, that are conveyed to the repository center.

15. The system of claim 1, wherein the internal device is attached to an internal wall-surface of the container, and the external device is attached to an external wall-surface of the container.

16-18. (canceled)

19. The system of claim 2, wherein each of the internal and the external devices comprising a transceiver for communicating with one or more sensors that are outside of the device casing.

20. (canceled)

21. The system of claim 1, wherein each device within a pair of internal and external devices has a unique ID, and wherein the internal and external devices are paired prior to monitoring the container.

22. (canceled)

23. A device for monitoring a container’s cargo, comprising sensors and a sampling-rate manager, wherein the sampling rate of the sensors and storage of sample rate records are dynamically altered by said sampling-rate manager based on sensing measurements made by said sensors.

24. The device of claim 23, comprising:
a plurality of sensors divided into a first group of sensors and a second group of sensors; and
an autonomous sampling-rate manager which is configured to:
(a) based on one or more excess of bound interrupts from said first group of sensors and a first group threshold, determine whether to wake up the device to sample and store within a memory storage a sample-record reflecting data measured by both said first and second groups of sensors; and
(b) based on measurements from said second group of sensors and a second-group threshold, determine whether to increase or decrease a period until a next sampling of the sensors.

25. (canceled)

26. The device of claim 24, wherein said sampling rate manager reduces a previously set sampling-rate after several cases of non-exceeding the first-group’s threshold or the second-group’s threshold.

27. The device of claim 24, wherein said determination regarding the first group of sensors and said determination regarding the second group of sensors are based on a predefined weight which is given to each sensor.

28. The device of claim 24, wherein a timestamp is respectively associated with each stored sample-record.

29. (canceled)

30. The device of claim 24, configured to synchronize sample-records with another monitoring device.

31. The device of claim 24, further comprising a GPS sensor to acquire location and to associate the location with at least one stored sample-record.

32. The device of claim 24, comprising a transceiver for communicating with one or more sensors that are outside of a casing of the device.
